(19) United States
(12) Patent Application Publication
(10) Pub. No.: US 2011/0078702 A1
(43) Pub. Date: Mar. 31, 2011

(54) MULTIPROCESSOR SYSTEM

(75) Inventor: Tetsu HOSOKI, Osaka (JP)

(73) Assignee: PANASONIC CORPORATION, Osaka (JP)

(21) Appl. No.: 12/962,165

(22) Filed: Dec. 7, 2010

Related U.S. Application Data
(63) Continuation of application No. PCT/JP2009/002571, filed on Jun. 8, 2009.

(30) Foreign Application Priority Data
Jun. 11, 2008 (JP) 2008-153199

(51) Int. Cl. G06F 9/48

(52) U.S. Cl. 718/108

(57) ABSTRACT

To suppress bias in processors executing a non-routinely-executed program such as event processing, and so on, and thus improve multiprocessor system performance. For this purpose, a multiprocessor system includes: a first context memory which is shared and stores context data of a program that is non-routinely executed by any one of plural processors; saving-and-restoring control units of a same number as the processors, each of which, when an execution request for a program is issued to the corresponding processor, saves and stores context data between the first context memory in the case where the requested program is the program that is non-routinely executed; and a selecting-and-requesting unit which, each time an execution request for the program that is non-routinely executed is issued, requests execution of such program to a selected processor.

### CROSS REFERENCE TO RELATED APPLICATION

This is a continuation application of PCT application No. PCT/JP2009/002571 filed on Jun. 8, 2009, designating the United States of America.

### BACKGROUND OF THE INVENTION

(1) Field of the Invention

The present invention relates to a technique of efficiently executing programs in parallel in a multiprocessor system.

(2) Description of the Related Art

With conventional multiprocessor systems, there is a method in which switching of programs or tasks is executed in an operating system (OS), and switching of contexts, which are task-specific information, such as program counters and stacks which are necessary for the execution of tasks, is managed by the OS (for example, Patent Reference 1: Japanese Unexamined Patent Application Publication No. 2005-043959).

Furthermore, there is also a method in which context switching is executed using hardware in a processor (for example, Patent Reference 2: Japanese Unexamined Patent Application Publication No. 2003-271399).

### SUMMARY OF THE INVENTION

However, when executing context switching using an OS, overhead due to context saving and restoring occurs and becomes a cause for performance deterioration. Furthermore, in the case of executing context switching using hardware in each of plural processors, when an interrupt brought about by an execution request for a non-routinely executed program is performed on a specified processor, scheduling inhibition due to the interrupt of the non-routinely executed program occurs only in such processor. As such, balance between the plural processors cannot be achieved, and the performance requirement for the programs routinely executed by the specified processor to which the performance requirement for the non-routinely-executed program (factored with occurrence frequency) has been simply added becomes the processor performance requirement.

Consequently, the present invention has as objects to solve the above-described problems and to achieve performance balance in the plural processors without incurring overhead due to context saving and restoring, thereby minimizing the performance requirement for each processor and obtaining high performance from the system as a whole.

In order to solve the above-described problems, the multiprocessor system according to the present invention includes: plural processors each of which executes plural programs while switching between the programs; a first context memory which is shared by the processors and stores context data of a program that is non-routinely executed by any one of the processors; second context memories of a same number as the processors, each of which is exclusively used by a corresponding one of the processors and stores context data of a program that is routinely executed by the corresponding processor; saving-and-restoring control units of a same number as the processors, each of which is exclusively used by a corresponding one of the processors, and is configured, when an execution request for a program is issued to the corresponding processor, to select the first context memory when the requested program is the non-routinely-executed program, and select the second context memory when the requested program is the routinely-executed program, and to save and restore the context data of the requested program between the corresponding processor and the selected one of the first and second context memories; and a selecting-and-requesting unit configured, each time an execution request for the non-routinely executed program occurs, to select any one of the processors, and to request execution of the non-routinely-executed program to the selected processor. It should be noted that “each A among plural As performs B (is a B)” is described as “each of plural As performs B (is a B)”. Each second context memory among the second context memories stores the context data of programs routinely executed by the processor corresponding to such second context memory. Such second context memory is exclusively used by such processor.

With this configuration, each of the processors can freely execute the routinely-executed program, using the second context memory exclusively used by the processor, regardless of the operation of another processor. For example, each of the processors can freely perform scheduling to select which among routinely-executed programs to execute, without being inhibited by the operation of another processors, and thus eliminating the need for large data transfers, such as data transfer to the processor from the other processor. On the other hand, a program to be non-routinely executed by any one of the processors, such as a program that is non-routinely executed by any one of the processors according to a non-routine interrupt such as an interrupt according to a user input for example, can be executed by any of the processors through the use of the second context memory by the processor executing such program. Accordingly, it is possible to prevent deterioration in the performance of the multiprocessor system due to a situation in which, each time an execution request occurs, a processor selected during such occurrence executes the execution request, and the selection of the processor for the execution is biased towards a small number of processors, for example one processor. Furthermore, since the function of a processor for executing a non-routinely-executed program is sufficiently dispersed among the processors, instances where the execution of the routinely-executed programs described above is inhibited by the execution of a non-routinely-executed program can be reduced, and conversely, inhibition of the execution of a non-routinely-executed program due to the execution of a routinely-executed program can be prevented. As such, deterioration of the performance of the multiprocessor system can be prevented and the performance of the multiprocessor system can be improved.

It should be noted that a routinely-executed program may be a so-called service program, a so-called daemon program, or a server-use program for a (HyperText Transfer Protocol) HTTP server, and the like, or a monitoring program which constantly monitors a subject.

On the other hand, a non-routinely-executed program may be an event processing program which processes various events such as the occurrence of, for example, a user input such as a key input, an input according to communications, and division by 0.

Here, the multiprocessor system may further include a main memory which is shared by the processors, wherein each of the processors may execute the non-routinely-executed program and the routinely-executed program, using the main memory.

With this configuration, for example, each of the processors executes a program using the exclusive memory that is exclusively used by such processor. Accordingly, compared to the case where the selected program takes a long time to obtain, from the exclusive memory of a processor other than the processor, data such as intermediate data midstream into the processing of a non-routinely-executed program, the delay in obtaining data midstream into the processing of the non-routinely-executed program can be eliminated, and thus allowing further high-speed operation by the multiprocessor system.

Here, in the multiprocessor system, each of the processors may include: plural register groups; and a register group selecting unit configured to select any one of the register groups, as an execution register group to be used by the processor in the execution of a program, and to select one of the register groups other than the selected register group, as a saving-and-restoring register group for the saving and the restoring of context data, and each of the processors may execute a program, using the register group selected as the execution register group by the register group selecting unit of the processor, and each of the saving-and-restoring control units may perform the saving and the restoring of the context data with respect to the selected saving-and-restoring register group, simultaneously with the execution of the program by the corresponding processor using the selected execution register group.

With this configuration, for example, saving and restoring of context data is performed in parallel with the execution of a program in which the execution register group is used, and thus, by performing the saving and restoring of context data simultaneously with the execution, it is possible to prevent the occurrence of overhead (delay time) in the processing of saving and restoring, and in the processing of the execution of the program, and thus it is possible to increase the speed of the multiprocessor system.

Here, the multiprocessor system may be a shared memory-type multiprocessor system in which each of the processors includes a local cache memory.

With this configuration, it is possible to prevent the processing of a routinely-executed program from causing unnecessary operations outside the processor executing the program, and prevent the occurrence of unnecessary operations in the processor in the processing of the program due to an operation performed outside the processor.

Here, each time an execution request for the non-routinely executed program occurs, the selecting-and-requesting unit may select, from the processors, a processor that is different from a processor selected in a previous occurrence of the execution request for the non-routinely-executed program.

With this configuration, it is possible to have all the processors perform the processing of the non-routinely-executed program, with the same amount of processing each. Therefore, the processing of the non-routinely-executed program is reliably and sufficiently dispersed among plural processor, and the performance of the multiprocessor can be sufficiently and reliably improved.

It should be noted that, for example, the selecting-and-requesting unit may hold identification data identifying one of the processors, select the processor identified by the held identification data, and update the held identification data with identification data identifying a processor other than the selected processor, each time the selection is performed.

Here, the selecting-and-requesting unit may detect an operational state of each of the processors, and select, from the processors, a processor having a predetermined correspondence relationship with the detected operational state.

This configuration detects the operational state of each processor, such as whether any of the respective processors is in an operational state such as a sleep state (idle state), that is, whether any of the processors is in a predetermined state in which there is leeway for executing a non-routinely-executed program. Then, based on this detection, it is possible to select the appropriate processor that corresponds to the operational state, such as when a processor that is in the sleep state is selected. Therefore, it is possible to appropriately select a processor having a suitable operating state situation at the time of selection, and thus the performance of the multiprocessor system can be sufficiently and reliably improved.

Furthermore, in solving the previously-mentioned problems, another multiprocessor system according to the present invention may adopt the following configuration. That is, (a) such other multiprocessor system includes: plural processors each of which executes plural programs while switching between the programs; a main memory which is shared by the processors, second context memories each of which is exclusively used by a corresponding one of the processors and stores context data of one or more programs that are routinely executed by the corresponding processor; a first context memory which is shared by the processors and stores context data of one or more programs that are non-routinely executed by any one of the processors; a selecting-and-requesting unit configured, each time an execution request for the one or more non-routinely executed program occurs, to determine which one of the processors to select, and to request the execution to the selected processor; and process control units each of which is exclusively used by a corresponding one of the processors and is configured to select one of the first and second context memories according to a predetermined program switching timing or the execution request from the selecting-and-requesting unit, and to save and restore context data with respect to the processor that is connected.

With this, the processing for a non-routinely-executed program can be dispersed among the processors, and routinely-executed programs can be independently scheduled in each of the processors as a local task. This contributes to the improvement of multiprocessor system performance through efficient program execution, while maintaining ease of scheduling.

In addition, (b) each of the processors may include: plural register groups; and a register group selecting unit configured to select any one of the register groups, as a program execution target, and to select one of the register groups that are not selected as the program execution target, as a context saving and restoring target, and the processor may execute a program, using the register group selected by the register group selecting unit, and perform the saving and the restoring of the context data with respect to the register group selected as the context saving and restoring target in parallel with the execution of the program.

This contributes to efficient program execution while maintaining ease of scheduling, without overhead due to saving and restoring.

In addition, (c) the multiprocessor system may be a shared memory-type multiprocessor system in which each of the processors includes a local cache memory.

Accordingly, since a routinely-executed program is not moved between processors, it becomes possible to execute a program without incurring overhead due to snooping, and so on, for maintaining the coherence of program instructions and data placed in the local cache.

In addition, (d) the selection object switching unit may switch the selection object for the processors each time an execution request for one or more of the programs that are non-routinely executed, according to a predetermined order.

This allows the number of times a non-routinely-executed program is allocated to be evened-out, thus allowing efficient program execution, and thus contributing to the improvement of multiprocessor system performance.

Alternatively, (e) the selection object switching unit may determine the selection object based on the operational state of the processors.

This allows the allocation of a processor for the non-routinely-executed program to be distributed to programs having leeway, such as an idle state, at that point in time, and thus contributing to the improvement of multiprocessor system performance.

Alternatively, each of the processors may include an event detecting unit which detects (i) the occurrence of an event that interrupts the operation of one or more programs that are routinely executed and (ii) the resolution of such interrupting event, and controls the stopping and resumption of the programs, and the selection object switching unit may determine the selection object based on event information from the event detecting unit.

This allows the allocation of a non-routinely-executed program to the processors to be flexibly distributed among the processors according to the event information of each processor, thus contributing to the improvement of multiprocessor system performance.

Alternatively, (g) each of the processors may include an event detecting unit which detects (i) the occurrence of an event that interrupts the operation of one or more programs that are routinely executed and (ii) the resolution of such interrupting event, and controls the stopping and resumption of the programs, and the selection object switching unit may determine the selection object based on a history within a predetermined period of the event information from the event detecting unit.

This allows the allocation of a non-routinely-executed program to the processors to be flexibly distributed among the processors according to the event information which includes past event information of each processor, thus contributing to the improvement of multiprocessor system performance.

It should be noted that the following configuration may also be adopted. Specifically, a multiprocessor system configuration may be adopted where the multiprocessor system includes: local context memories each of which is exclusively used by a corresponding one of plural processors and stores context data of a routinely-executed program; a shared context memory which is shared by the processors and stores context data of a non-routinely-executed program, and the multiprocessor system can execute high-speed event processing while maintaining real-timeliness, by executing the routinely-executed program as a local thread in each of the processors, and executing the non-routinely-executed program by distributing it to any of the processors.

According to the present invention, a routinely-executed program is executed by a specified processor and thus overhead for cache coherence maintenance does not occur, and because the non-routinely-executed program can be distributed among the processors, the amount of performance required by the non-routinely-executed program can be dispersed among the processors, thus contributing to the improvement of multiprocessor system performance.

### FURTHER INFORMATION ABOUT TECHNICAL BACKGROUND TO THIS APPLICATION

The disclosure of Japanese Patent Application No. 2008-153199 filed on Jun. 11, 2008, including specification, drawings and claims is incorporated herein by reference in its entirety.

The disclosure of PCT Application No. PCT/JP2009/002571 filed on Jun. 8, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a multiprocessor system in a first embodiment;

FIG. 2 is a block diagram showing a configuration a process control unit in the first embodiment;

FIG. 3 is a block diagram showing a configuration of a selection object switching unit in the first embodiment;

FIG. 4 is a timing chart describing context switching in the first embodiment;

FIG. 5 is a timing chart describing program execution in the first embodiment;

FIG. 6 is a timing chart describing program execution in the first embodiment;

FIG. 7 is a block diagram showing a configuration of a multiprocessor system in a second embodiment;

FIG. 8 is a block diagram showing a configuration of a process control unit in the second embodiment;

FIG. 9 is a block diagram showing a configuration of a selection object switching unit in the first embodiment;

FIG. 10 is a timing chart describing program execution in the second embodiment;

FIG. 11 is a block diagram showing a configuration of a multiprocessor system in a third embodiment;

FIG. 12 is a block diagram showing a configuration of a selection object switching unit in the third embodiment; and

FIG. 13 is a timing chart describing program execution in the third embodiment.

### DESCRIPTION OF THE PREFERRED EMBODIMENTS

### First Embodiment

Hereinafter, a first embodiment according to the present invention shall be described with reference to the Drawings.

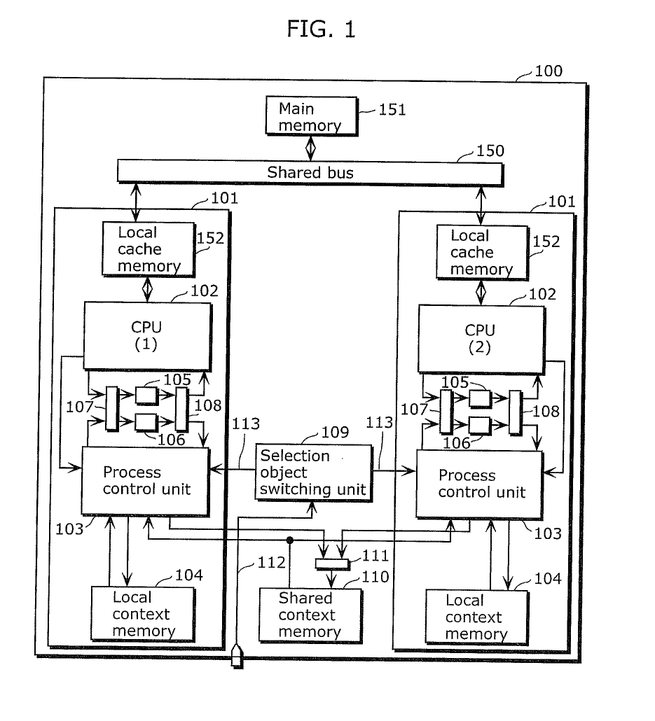

FIG. 1 is a block diagram showing a configuration of a multiprocessor system 100 in the first embodiment according to the present invention.

The multiprocessor system 100, as shown in FIG. 1, includes two processor elements 101, a selection object switching unit 109, a shared context memory 110, a context data selector 111, a shared bus 150, and a main memory 151.

Each of the two processor elements 101 include a CPU 102, a process control unit 103, a local context memory 104, a register group 105, a register group 106, a context data selector 107, a context data selector 108, and a local cache memory 152. It should be noted that “each A among plural As is a B (performs B)” is described as “each of plural As is a B (performs B)”. Each of the processor elements 101 includes a CPU 102 for such processor element 101 (refer to FIG. 1). The processor elements 101, as a whole, include CPUs 102 of a number (two) that is the same as the number (two) of processor elements 101 included in the plural processor elements 101.

Hereinafter, the processor element 101 on the left side of FIG. 1 shall be called left-side processor element 101 and the processor element 101 on the right side of FIG. 1 shall be called right-side processor element 101.

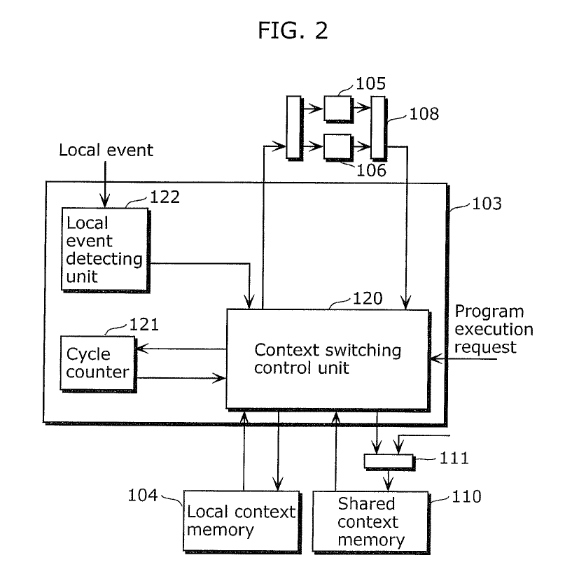

FIG. 2 is a block diagram showing an internal configuration of the respective process control units 103 (FIG. 1) in the first embodiment according to the present invention. The internal configuration of the process control unit 103 to be described below is, for example, the internal configuration of the left-side processor element 101, and the other, that is, the right-side processor element 101 has the same internal configuration as the internal configuration of the left-side processor element 101 described below.

The process control unit 103, as shown in FIG. 2, includes a context switching control unit 120, a cycle counter 121, and a local event detecting unit 122.

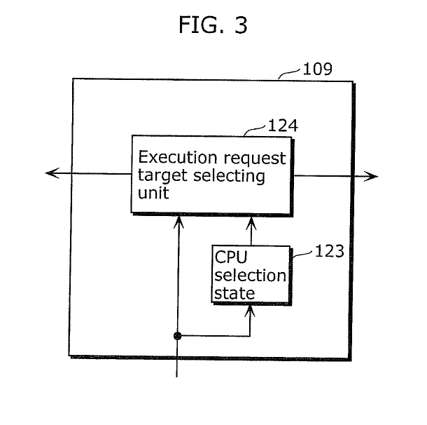

FIG. 3 is a block diagram showing an internal configuration of the selection object switching unit 109 (FIG. 1) in the first embodiment according to the present invention.

The selection object switching unit 109, as shown in FIG. 3, includes a CPU selection state 123, and an execution request destination selecting unit 124.

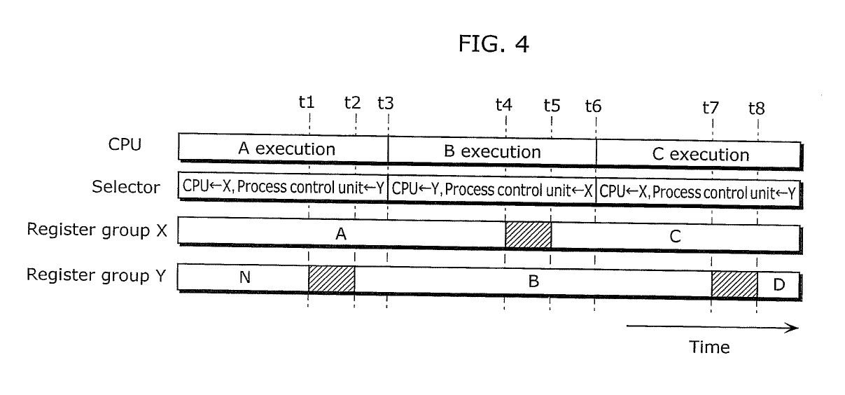

FIG. 4 is a timing chart describing (i) the operation of a selector including the context data selector 107 and the context data selector 108 which select the data of either the register group 105 or the register group 106, and the (ii) process of executing programs A to C in the CPU 102 which uses the data selected by the selector.

It is to be noted that in the description in FIG. 4, programs A to C are, for example, programs executed by the CPU 102 of the left-side processor element 101, and the other, that is, the CPU 102 of the right-side processor element 101 executes programs according to the same process of executing programs in the description in FIG. 4.

The CPU 102 executes the program A during a period up to a time t3.

In FIG. 4, in a period up to the time t3, the selector including the context data selector 107 and the context data selector 108 selects the register group 105 shown on the upper side of FIG. 1 as a program execution target register group for the read and write accesses brought about by the program execution by the CPU 102, and selects the other, that is, the register group 106 in the lower side as a context saving and restoring target register group for the context data read (store) and write (restore) accesses by the process control unit 103. It should be noted that, with regard to the registers, in the case where the multiprocessor system 100 does not have only the two register groups of the register group 105 and the register group 106 as shown in FIG. 1, but instead includes three or more register groups, another register group other than the register group that is the program execution target register group is selected from among the respective register groups as the context saving and restoring target register group.

During the period up to the time t3, the CPU 102 executes the program A by using the context of the program A held in the register group 105 selected as the execution target register group by the context data selector 107 and the context data selector 108.

In addition, during a period from a time t1 up to a time t2, in order to restore context data of program B which, according to scheduling, is to be executed next by the CPU 102, the process control unit 103 performs, with respect to the lower-side register group 106 which is selected as the context saving and restoring target register group by the selector and is not the program execution target in the period from the time t1 up to the time t2, the saving of context data of an already existing program N stored in such saving and restoring target register group and the restoring of the context data of program B to the saving and restoring target register group, in parallel with the program execution by the CPU 102.

In the time t3, the context data selector 107 and the context data selector 108 switches selection objects so as to select the lower-side register group 106 for accesses from the CPU 102, and select the upper-side register group 105 for accesses from the process control unit.

With this, the CPU 102 can promptly start the execution of program B from the time 3, without incurring overhead caused by context saving and restoring processes.

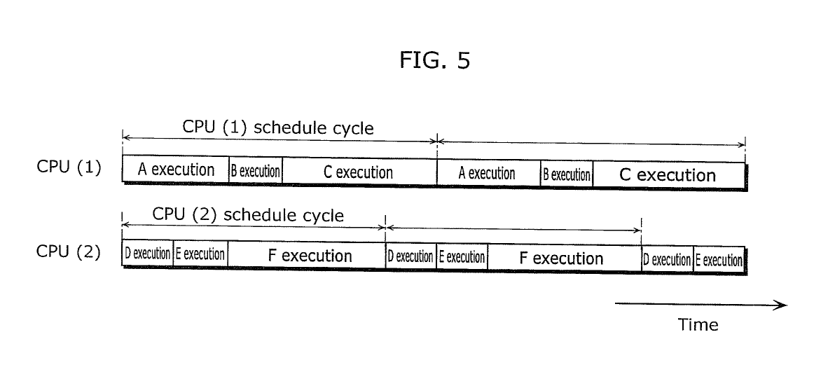

FIG. 5 is a timing chart describing the operation of the multiprocessor system 100 when the CPU 102 executes the routinely-executed programs.

As shown in FIG. 5, when the multiprocessor system 100 does not have an execution request for the non-routinely executed program, each of the CPUs 102 executes the routinely-executed programs stored in the local context memory 104 corresponding to the CPU 102 out of the two local context memories 104, and switches the program to be executed among the respective routinely-executed programs at an independent schedule cycle.

Here, as an example, a case is shown where the routinely-executed programs A, B, and C are executed virtually in parallel while being sequentially switched in one of the CPUs 102 (for example the CPU 102 of the left-side processor element 101), and routinely-executed programs D, E, and F are executed virtually in parallel while being sequentially switched in the other of the CPUs 102 (for example the CPU 102 of the right-side processor element 101).

At the timing when the program to be executed is to be switched from the currently-executed program to another program, the context switching control unit 120 determines the next program to be executed (for example program B) based on a scheduling sequence included in the context data of each program stored in the local context memory 104, and starts context data saving and restoring.

Subsequently, after finishing such saving and restoring, the process control unit 103 switches the selection object of the selector including the context data selector 107 and the context data selector 108. Specifically, the process control unit 103 causes the register group on which context data saving and restoring was performed immediately before the switching, that is the register group selected as the context saving and restoring target register group immediately before, to be selected as the program execution target register group described above, and causes the execution of the program (program B) of the context data for which saving and restoring was performed immediately before.

Then, when the switching of a program to be executed, such as that described above, occurs, the context switching control unit 120 (FIG. 2) notifies, to the cycle counter 121 (FIG. 2), a counter initial value included in the context data of the program (for example program B) for which execution is to be newly started according to the switching.

Upon receiving such notification, the cycle counter 121 sets, into itself, the notified counter initial value and, after the setting, down-counts every clock cycle. When the count value becomes 0, the cycle counter 121 causes the context switching control unit 120 to start the switching to the next program (for example program C) by notifying the context switching control unit 120 that the counter value has become 0. The timing for switching the program to be executed, such as the switching from program A to program B, and the switching from program B to program C, as described above, is, for example, the timing when such notification is given. When there is such a notification, the process control unit 103 switches the program to be executed.

It is to be noted that (i) enabling program execution without saving and restoring overhead by executing the context data saving and restoring in parallel with the program execution described above, and (ii) various publicly known techniques regarding techniques of various scheduling methods, may be applied to the multiprocessor system 100. For the sake of simplifying description, detailed description of points related to publicly known techniques shall be omitted.

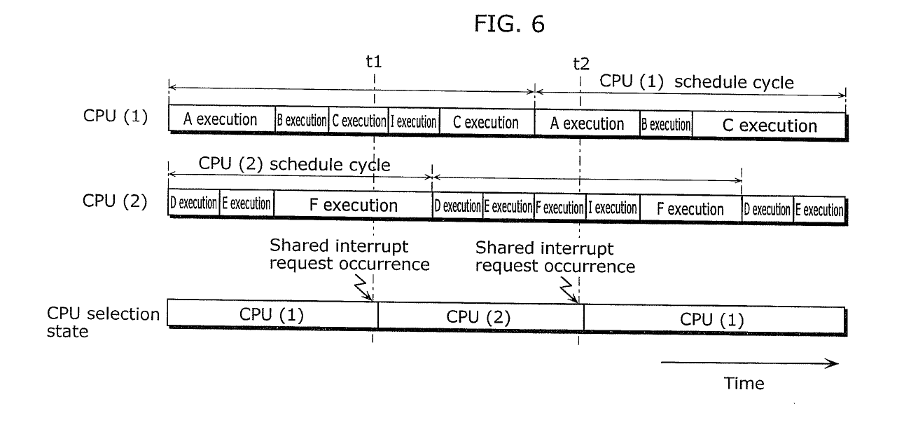

FIG. 6 is a timing chart describing the operation of the CPU 102 when an execution request for a non-routinely executed program occurs.

FIG. 6 shows an example of a case where the routinely-executed programs A, B, and C are executed virtually in parallel while being sequentially switched in one of the CPUs 102 (for example the CPU 102 of the left-side processor element 101), and routinely-executed programs D, E, and F are executed virtually in parallel while being sequentially switched in the other of the CPUs 102 (for example the CPU 102 of the right-side processor element 101), and, as the cause of an execution request for a non-routinely executed program, a shared interrupt request that is independent of the respective programs occurs. For example, such shared interrupt request includes an interrupt request occurring due to a user input or an interrupt request occurring due to the receipt of a communication.

The time at which the shared interrupt request (shared interrupt request signal 112 in FIG. 1) occurs is indicated in the time t1.

In the case where the shared interrupt request occurs at the time t1, in order that one of the CPUs 102 executes the non-routinely executed program, the execution request destination selecting unit 124 passes a program execution request to the corresponding process control unit 103, based on selection information of the CPU selection state 123 (FIG. 3).

Here, the CPU selection state 123 is configured of a register which holds data specifying either the register group 105 or the register group 106 as the selection object of the selection by the selection object switching unit 109, and updates the selection object CPU 102 specified by the held data, each time a shared interrupt request is received, and thus the selection object CPU 102 is updated so that each of the CPUs 102 is sequentially specified. It should be noted that, for example, the CPU selection state 123 (i) includes an updating circuit which performs updating when a shared interrupt request is received, and (ii) performs updating upon receiving a shared interrupt request by using such updating circuit.

Upon receiving a program execution request, that is, when the above-described shared interrupt occurs and the selection object switching unit 109 issues a program execution request to the process control unit 103, the process control unit 103, treating a non-routinely executed program I as the program to be executed next, interrupts the scheduling of routinely-executed programs, and saves the already-existing context data of a routinely-executed program, from the program execution target register group to the local context memory 104, and restores, from the shared context memory 110 to the context saving and restoring target register group, the context data of the non-routinely executed program which is the program to be executed next.

After the context data is restored from the shared context memory 110 by the process control unit 103 in the manner described above, the context switching control unit 120 (FIG. 2) switches the selection object of the context data selector 107 and the context data selector 108. With the performance of such switching, the register group into which the restored context data is written is selected as the program execution target register group, and the CPU 102 starts the execution of the program I using such context data. In this manner, the CPU 102 executes the program I during a period indicated by the reference symbol “I execution” in FIG. 6.

It should be noted that the cycle counter 121 stops, that is, does not perform the down count and instead maintains the same counter value while the non-routinely executed program is being executed in the above-described manner, and the next switching timing is determined by the end of the execution of program I. In other words, in the example in the present embodiment, the interrupted program C is assigned as the next execution object of the CPU 102 after program I is finished (refer to “C execution” after “I execution” in FIG. 6).

When restoring the context data of the program I stored in the non-program execution object register group, that is, the context saving and restoring target register group, after the execution of program I is finished, the process control unit 103 restores such context data to the shared context memory 110.

Each one of the two processor elements 101 performs a process such as that described above. Accordingly, during program execution according to a shared interrupt request occurring at a time t1, the CPU selection state 123 previously updates the selection object CPU 102 to the other CPU 102 (for example the right-side CPU 102 in FIG. 1) that is different from the CPU 102 that performs the execution of such program (for example, the left-side CPU 102 in FIG. 1), thus, when a shared interrupt request occurs at the time t2, the execution of the non-routinely executed program is performed by the other CPU 102, that is, the CPU other than the CPU 102 involved in the execution at the time t1.

As described above, according to the multiprocessor system 100 in the present embodiment, each of the routinely-executed programs are separately scheduled and executed by the respective processors (the right-side processor element 101 and the left-side processor element 101 in FIG. 1). As such, independent scheduling for each processor becomes possible and there is no movement (data) of routinely-executed programs between processors. For this reason, there is no overhead due to cache snooping, and so on, for maintaining cache coherence via the shared bus 150, and efficient program execution becomes possible. In addition, with regard to the execution of a non-routinely executed program such as event processing, the processing load thereof can be dispersed and evened-out among plural CPUs, and thus allowing the required maximum processing performance of a processor to be reduced compared to when the event processing is assigned to a particular processor.

It should be noted that although a two processor configuration is shown in the present embodiment, the present invention is not limited to a multiprocessor system including two processors, and can be applied to a multiprocessor system including three or more processors.

Furthermore, although a two register group (register group 105, register group 106: see FIG. 1) configuration is shown in the present embodiment, the present invention can also be applied in a case where, depending on scheduling methods, and the like, for executing while switching plural programs, the frequency of saving and restoring can be reduced more with a configuration having three or more register groups.

In this manner, there is configured a multiprocessor system (multiprocessor system 100) including: plural processors (left-side processor element 101, right-side processor element 101: FIG. 1) each of which executes plural programs while switching between the programs; a first context memory (shared context memory 110) which is shared by the processors and stores context data of a program that is non-routinely executed by any one of the processors; second context memories (local context memory 104 of the left-side memory element 101, local context memory 104 of the right-side memory element 101) of a same number as the processors, each of which is exclusively used by a corresponding one of the processors and stores context data of a program that is routinely executed by the corresponding processor; saving-and-restoring control units (process control unit 103 of the left-side memory element 101, process control unit 103 of the right-side memory element 101) of a same number as the processors, each of which is exclusively used by a corresponding one of the processors, and is configured, when an execution request for a program is issued to the corresponding processor, to select the first context memory when the requested program is the non-routinely-executed program, and select the second context memory when the requested program is the routinely-executed program, and to save and restore the context data of the requested program between the corresponding processor and the selected one of the first and second context memories; and a selecting-and-requesting unit (selection object switching unit 109) configured, each time an execution request for the non-routinely executed program occurs, to select any one of the processors, and to request execution of the non-routinely-executed program to the selected processor.

With this, each of the processors can freely execute routinely-executed programs, a program that is non-routinely executed by any one of the processors can be executed by any processor, and the processor which has to execute non-routinely-executed programs can be sufficiently dispersed among plural processors. Therefore, for example, it becomes possible to minimize inhibition of the execution of a routinely-executed program due to the execution of a non-routinely executed program, and inversely, to prevent the inhibition of the execution of a non-routinely executed program due to the execution of a routinely-executed program.

Here, the multiprocessor system may further include a main memory (main memory 151) which is shared by the processors, wherein each of the processors may execute the non-routinely-executed program and the routinely-executed program, using the main memory.

Here, in the multiprocessor system, each of the processors may include: plural register groups (register group 105, register group 106); and a register group selecting unit (selector including the context data selector 107 and the context data selector 108) configured to select any one of the register groups, as an execution register group to be used by the processor in the execution of a program, and to select one of the register groups other than the selected register group, as a saving-and-restoring register group for the saving and the restoring of context data, and each of the processors may execute a program, using the register group selected as the execution register group by the register group selecting unit of the processor, and each of the saving-and-restoring control units may be configured to perform the saving and the restoring of the context data with respect to the selected saving-and-restoring register group, simultaneously with the execution of the program by the corresponding processor using the selected execution register group.

Here, the multiprocessor system may be a shared memory-type multiprocessor system in which each of the processors includes a local cache memory (local cache memory 152 of the left-side processor element 101, local cache memory 152 of the right-side processor element 101).

Here, each time an execution request for the non-routinely executed program occurs, the selecting-and-requesting unit may select, from the processors, a processor that is different from a processor selected in a previous occurrence of the execution request for the non-routinely-executed program.

It should be noted that the selecting-and-requesting unit holds identification data identifying one of the processors (selection data of the CPU selection state 123 (FIG. 3)), selects the processor identified by the held identification data (for example, the processor element 101 on the upper stage in FIG. 6 that is selected at the time t1 in FIG. 6), and updates the held identification data with identification data identifying a processor (for example, the processor element 101 on the lower stage in FIG. 6 that is selected at the time t2 in FIG. 6) other than the selected processor, each time the selection is performed.

### Second Embodiment

Hereinafter, a second embodiment according to the present invention shall be described with reference to the Drawings.

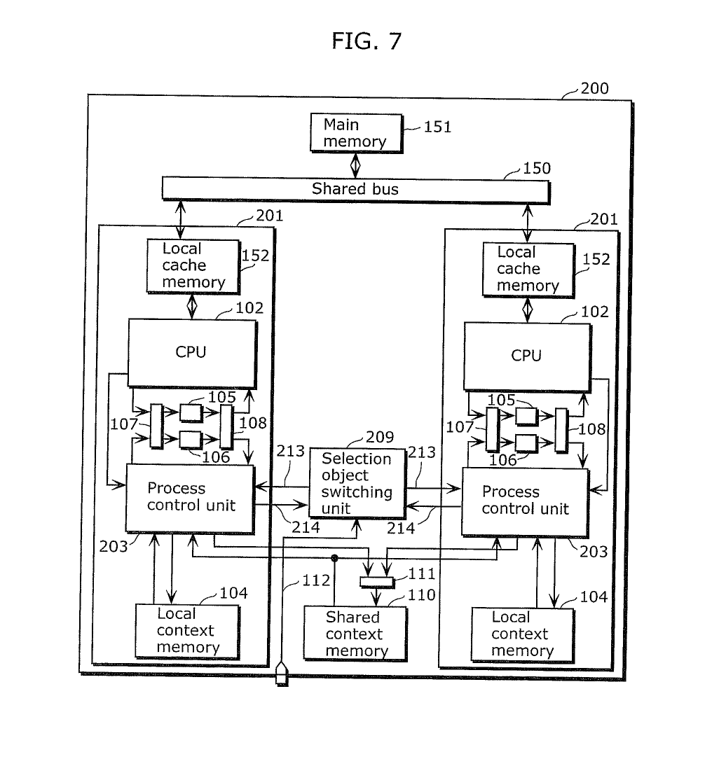

FIG. 7 is a block diagram showing a configuration of a multiprocessor system 200 in the second embodiment according to the present invention. It should be noted that constituent elements that are the same as those in the first embodiment according to the present invention shall be assigned the same numeric references and their description shall be omitted.

The multiprocessor system 200, as shown in FIG. 7, includes two processor elements 201, a selection object switching unit 209, the shared context memory 110, the context data selector 111, the shared bus 150, and the main memory 151.

In addition, each of the two processor elements 201 include the CPU 102, a process control unit 203, the local context memory 104, the register group 105, the register group 106, the context data selector 107, the context data selector 108, and the local cache memory 152.

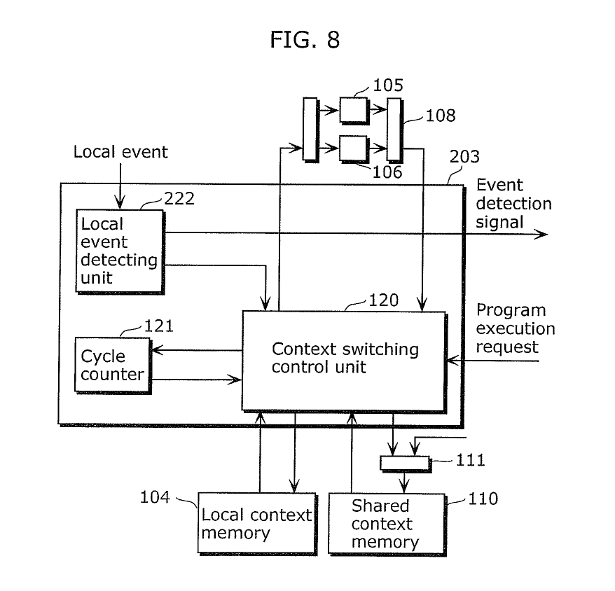

FIG. 8 is a block diagram showing an internal configuration of each of the process control units 203 (FIG. 7) in the second embodiment according to the present invention.

The process control unit 203, as shown in FIG. 8, includes the context switching control unit 120, the cycle counter 121, and a local event detecting unit 222.

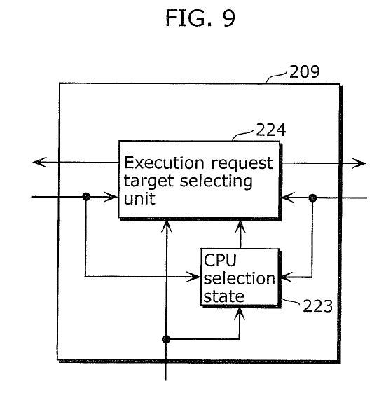

FIG. 9 is a block diagram showing the configuration of the selection object switching unit 209 (FIG. 7) in the second embodiment according to the present invention.

The selection object switching unit 209, as shown in FIG. 9, includes a CPU selection state 223, and an execution request destination selecting unit 224.

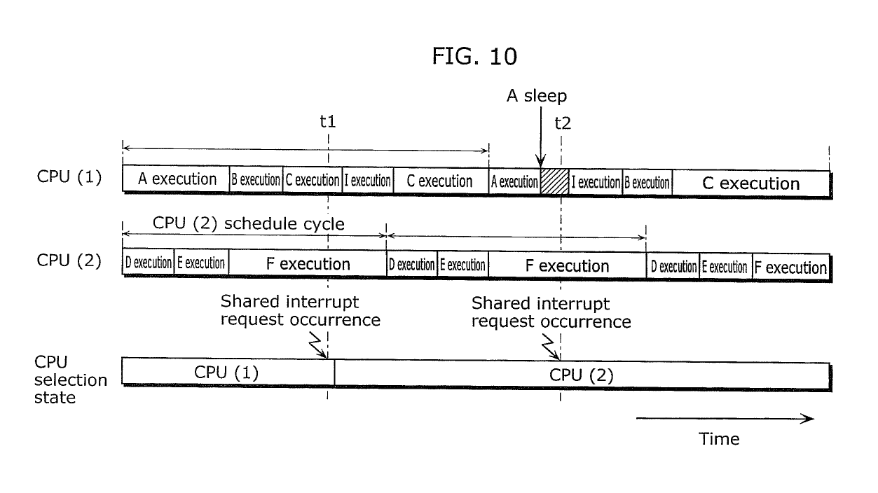

FIG. 10 is a timing chart describing the operation of the CPU 102 when an execution request for a non-routinely executed program occurs.

FIG. 10 shows an example of a case where the routinely-executed programs A, B, and C are executed virtually in parallel while being sequentially switched in one of the CPUs 102 (for example the CPU 102 of the left-side processor element 201 in FIG. 7), and routinely-executed programs D, E, and F are executed virtually in parallel while being sequentially switched in the other of the CPUs 102 (for example the CPU 102 of the right-side processor element 101 in FIG. 7), and, as the cause of an execution request for a non-routinely executed program, a shared interrupt request that is independent of the respective programs occurs.

Here, when a program being executed enters a sleep state when each of the CPUs 102 is executing a program, the CPU 102 places the remainder of the counter value set according to such program execution into the idle state, and does not schedule the programs other than the program in the sleep state until the counter value becomes 0. For example, the remainder of the counter value set according to the execution of the program A in FIG. 10 is treated as an idle state, and scheduling of the other programs is not performed until the counter value becomes 0.

A time t1 indicates a first time point at which a shared interrupt request occurs. Furthermore, a time t2 indicates a second time point at which a shared interrupt request occurs.

At the time t1 is a time at which a shared interrupt request occurs during a period in which neither of the two CPUs 102 are in a sleep state.

In the case where the shared interrupt request occurs at the time t1, in order that one of the CPUs 102 executes the non-routinely executed program, the execution request destination selecting unit 224 passes a program execution request to the process control unit 203 corresponding to the CPU 102, based on selection information of the CPU selection state 223.

It should be noted that the CPU selection state 223 updates the selection object CPU 102 each time a shared interrupt request is received, and thus the selection object CPU 102 is updated so that each CPU 102 is sequentially specified.

Upon receiving a program execution request, the process control unit 203, treating a non-routinely executed program I as the program to be executed next, interrupts the scheduling of routinely-executed programs, and saves the already-existing context data of a routinely-executed program into the local context memory 104, and restores the context data from the shared context memory 110.

After the context data is restored from the shared context memory 110, the context switching control unit 120 switches the selection object of the context data selector 107 and the context data selector 108. With the performance of such switching, the CPU 102 starts the execution of the program I.

It should be noted that, during the execution of the non-routinely executed program, the cycle counter 121 stops, and the timing for the next switching is determined by the end of the execution of program I. In other words, in the example in the present embodiment, the interrupted program C is assigned as the next execution object of the CPU 102, after program I is finished.

When the context data of the program I stored in the non-program execution object register group is to be restored after the execution of program I is finished, the process control unit 203 restores such context data to the shared context memory 110.

In the meantime, the time t2 is a time at which a shared interrupt request occurs during a period in which one of the two CPUs 102 is in the sleep state.

With regard to the shared interrupt request at the time t2, one of the CPUs 102 is in a sleep state at that point in time. The execution request destination selecting unit 224 (see FIG. 9), to which an event detection signal (see FIG. 8) including the sleep state is notified from the local event detecting unit 222 (FIG. 8), passes, based preferentially on the event detection over the state of the CPU selection state 123, a program execution request to the process control unit 203 corresponding to the CPU 102 in the sleep state so as to cause the CPU 102 in the sleep state to execute the non-routinely executed program. It should be noted that the CPU selection state 223 does not update when the execution request selecting unit 224 receives the event detection signal and the execution request is passed to the CPU 102 specified by the event detection signal.

As described above, according to the multiprocessor system 200 in the present embodiment, the routinely-executed programs are separately scheduled and executed by the respective processors, and thus independent scheduling for each processor becomes possible and there is no movement of routinely-executed programs between processors. Therefore, there is no overhead due to cache snooping for maintaining cache coherence via the shared bus 150, and efficient program execution becomes possible. In addition, with regard to the execution of a non-routinely executed program such as event processing, the processing load thereof can be dispersed and evened-out among plural CPUs, and thus allowing the required maximum processing performance of a processor to be reduced compared to when the event processing is assigned to a particular processor.

Moreover, when there is an idle state in any of the CPUs, more efficient program execution becomes possible by causing event processing to be performed in such CPU.

In this manner, the multiprocessor system 200 is configured to include a selecting-and-requesting unit (selection object switching unit 209) which detects the operational state of the processors, and selects the processor having a predetermined correspondence relationship with the detected operational state.

Here, the multiprocessor system is configured such that: the plural processors each include a stopping-and-resumption control unit (process control unit 203) which (i) detects (a) the occurrence of an event interrupting the execution of a routinely-executed program by the processor, and (b) the resolution of such event, (ii) stops the execution when such occurrence is detected, and (iii) resumes the stopped execution when such resolution is detected; and the selecting-and-requesting unit obtains information on the stopping and resumption from the stopping-and-resumption control unit, and selects the processor including such stopping-and-resumption control unit when the obtained information indicates that such processor is in an operational state following the stopping of the execution and preceding the resumption of the execution.

### Third Embodiment

Hereinafter, a third embodiment according to the present invention shall be described with reference to the Drawings.

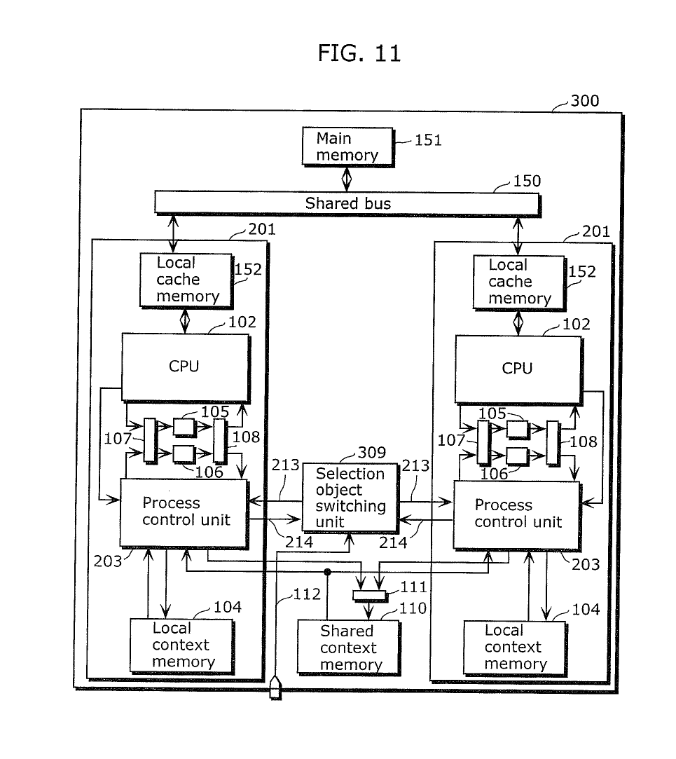

FIG. 11 is a block diagram showing a configuration of a multiprocessor system 300 in the third embodiment according to the present invention. It should be noted that constituent elements that are the same as those in the first and second embodiments according to the present invention shall be assigned the same numeric references and their description shall be omitted.

The multiprocessor system 300, as shown in FIG. 11, includes the two processor elements 201, a selection object switching unit 309, the shared context memory 110, the context data selector 111, the shared bus 150, and the main memory 151.

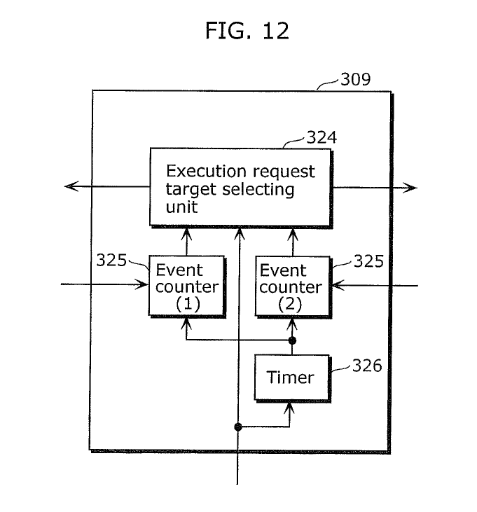

FIG. 12 is a block diagram showing a configuration of the selection object switching unit 309 in the third embodiment according to the present invention.

The selection object switching unit 309, as shown in FIG. 12, includes an execution request destination selecting unit 324, two event counters 325, and a timer 326.

Each of the event counters 325 counts up event detection signals from the local event detecting unit connected to the event counter 325, from among the respective local event detecting units included in the respective process control units 203 (see local event detecting unit 222 in FIG. 8), and resets the count value according to an overflow notification from the timer 326 or a shared interrupt request.

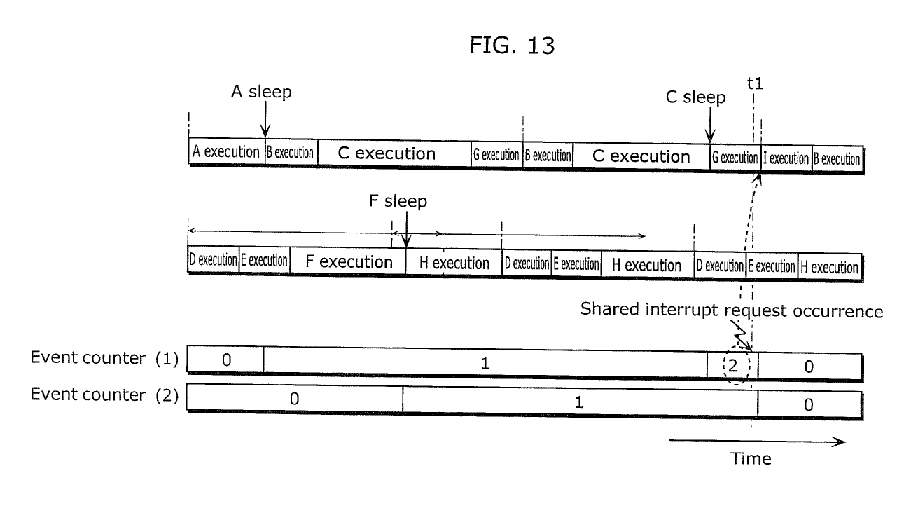

FIG. 13 is a timing chart describing the operation of the CPU 102 when an execution request for a non-routinely executed program occurs.

In FIG. 13, the routinely-executed programs A, B, C, and G are executed virtually in parallel while being sequentially switched in one of the CPUs 102 (for example, that in the left-side processor element 201). In addition, in FIG. 13, the routinely-executed programs D, E, F, and H are executed virtually in parallel while being sequentially switched in the other of the CPUs 102 (for example, that in the right-side processor element 201). Furthermore, FIG. 13 shows an example of a case where a shared interrupt request that is independent of the respective programs occurs as the cause of an execution request for a non-routinely executed program.

Here, when a program enters the sleep state, the CPU 102 executing such program starts the scheduling of programs other than such executed program, and transitions to the next program execution. For example, FIG. 13 illustrates the occurrence of operations, such as the one of the CPUs 102 starting the scheduling of the programs B, C, and G which are the other programs and transiting to the execution of program B, when the program A enters the sleep state.

A time t1 is the time at which a shared interrupt request occurs.

Each of the event counters 325 counts up the event detection history of the respective CPUs 102, and counts the transitions to the sleep state notified by event detection signals up to the time t1.

Subsequently, in the case where a shared interrupt request occurs at the time t1, in order that one of the CPUs 102 executes the non-routinely executed program, the execution request destination selecting unit 324 passes a program execution request to the corresponding process control unit 203, according to the magnitude of the respective values counted by the event counters 325. In this example, the execution request destination selecting unit 324 passes the program execution request to the process control unit 203 corresponding to the event counter 325 having the larger count value.

As described above, according to the multiprocessor system 300 in the present embodiment, the routinely-executed programs are separately scheduled and processed by the respective processors. As such, independent scheduling for each processor becomes possible and there is no movement of routinely-executed programs between processors. Therefore, there is no overhead due to cache snooping for maintaining cache coherence via the shared bus 150, and efficient program execution becomes possible. In addition, with regard to the execution of a non-routinely executed program such as event processing, the processing load thereof can be distributed more flexibly depending on the state of the CPUs.

In addition, the allocation of a non-routinely-executed program to the processor can be flexibly distributed among the processors depending on event information including past event information of the respective processors.

It should be noted that, although the present embodiment shows an example in which a processor having the larger count value for the local event of the processor is selected, the processor having the smaller count number may be selected, depending on the type of the local event. In addition, processors to which event processing is to be distributed may be determined according to combinations of cases.

(Modification)

It is also possible to configure a multiprocessor system according to a modification described below. Part of the multiprocessor system in the modification may be added to the multiprocessor system in any of the previously described embodiments, and part of the multiprocessor system in any of the previously described embodiments may be added to the multiprocessor system in the modification.

(1) A multiprocessor system in the modification is a multiprocessor system (multiprocessor system 100) that includes: a first processor and a second processor (left-side processor element 101, right-side processor element 101: FIG. 1); a shared context data storage unit (shared context memory 110) which is shared by the first processor and the second processor, and which stores context data of a non-routinely-executed program such as a program executed by one of the first processor and the second processor according to a non-routine interrupt such as an interrupt caused by, for example, a user input; two context data storage units (local context memory 104 of the left-side processor element 101, and local context memory 104 of the right-side processor element 101) each of which corresponds to one of the first processor and the second processor, stores the context data of a program that is non-routinely executed by the corresponding processor, and is used exclusively by the corresponding processor; saving-and-restoring control units (process control unit 103 of the left-side processor element 101, and process control unit 103 of the right-side processor element 101) each of which correspond to the first processor and the second processor, saves and restores context data of the non-routinely executed program between the corresponding processor and the shared context data storage unit, and saves and restores context data of routinely-executed programs of the corresponding processor between the corresponding processor and the context data storage unit exclusively used by the corresponding processor; and a non-routine execution processor selecting unit (selection object switching unit 109) which causes the non-routinely-executed program to be executed by the first processor when a predetermined condition is satisfied, and causes the non-routinely-executed program to be executed by the second processor when the predetermined condition is not satisfied.

It should be noted that a routinely-executed program may be a so-called service program, a so-called daemon program, or a server-use program for a (HyperText Transfer Protocol) HTTP server, and the like.

On the other hand, a non-routinely-executed program may be an event processing program for processing various types of events such as the occurrence of various exceptions such as the occurrence of a user input such as a key input, an input according to communications, or division by 0.

(2) In addition, the multiprocessor system in the modification is a multiprocessor system in which each of the saving-and-restoring control units, in the case where the program being executed by the processor corresponding to the saving-and-restoring control unit is a non-routinely-executed program, (i) restores the context data of the non-routinely-executed program stored by the shared context data storage unit to the predetermined execution-time storage unit to which the context data of programs executed by such processor is to be stored (the program execution object register group out of the register group 105 and the register group 106), when the execution of the non-routinely-executed program is to be started, and (ii), when the execution ends, saves the context data of the non-routinely-executed program after the end of the execution, from the execution-time storage unit to the context data storage unit. Moreover, in the case where the program being executed is a routinely-executed program, the saving-and-restoring control unit (i) restores, to the execution-time storage unit, the context data of the routinely-executed program stored by the context data storage unit exclusively used by the processor, when the execution of the routinely-executed program is to be started, and (ii), when the execution ends, saves the context data of the routinely-executed program after the end of the execution, from the execution-time storage unit to the context data storage unit.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be used as a multiprocessor system which includes plural processors, and executes both real-time processing and event processing.

What is claimed is:

1. A multiprocessor system comprising:
plural processors each of which executes plural programs while switching between the programs;
a first context memory which is shared by said processors and stores context data of a program that is non-routinely executed by any one of said processors;
second context memories of a same number as said processors, each of which is exclusively used by a corresponding one of said processors and stores context data of a program that is routinely executed by said corresponding processor;
saving-and-restoring control units of a same number as said processors, each of which is exclusively used by a corresponding one of said processors, and is configured, when an execution request for a program is issued to said corresponding processor, to select said first context memory when the requested program is the non-routinely-executed program, and select the second context memory when the requested program is the routinely-executed program, and to save and restore the context data of the requested program between said corresponding processor and the selected one of said first and second context memories; and
a selecting-and-requesting unit configured, each time an execution request for the non-routinely executed program occurs, to select any one of said processors, and to request execution of the non-routinely-executed program to said selected processor.

2. The multiprocessor system according to claim 1, further comprising
a main memory which is shared by said processors,
wherein each of said processors is configured to execute the non-routinely-executed program and the routinely-executed program, using said main memory.

3. The multiprocessor system according to claim 2,
wherein each of said processors includes:
plural register groups; and
a register group selecting unit configured to select any one of said register groups, as an execution register group to be used by said processor in the execution of a program, and to select one of said register groups other than the selected register group, as a saving-and-restoring register group for the saving and the restoring of context data, and
each of said processors is configured to execute a program, using said register group selected as the execution register group by said register group selecting unit of said processor, and
each of said saving-and-restoring control units is configured to perform the saving and the restoring of the context data with respect to the selected saving-and-restoring register group, simultaneously with the execution of the program by said corresponding processor using the selected execution register group.

4. The multiprocessor system according to claim 2,
wherein said multiprocessor system is a shared memory-type multiprocessor system in which each of said processors includes a local cache memory.

5. The multiprocessor system according to claim 2,
wherein, each time an execution request for the non-routinely executed program occurs, said selecting-and-requesting unit is configured to select, from said processors, a processor that is different from a processor selected in a previous occurrence of the execution request for the non-routinely-executed program.

6. The multiprocessor system according to claim 2,
wherein said selecting-and-requesting unit is configured to detect an operational state of each of said processors, and to select, from said processors, a processor having a predetermined correspondence relationship with the detected operational state.

7. The multiprocessor system according to claim 6,
wherein each of said processors includes
a stopping-and-resumption control unit configured to detect (i) an occurrence of an event interrupting the execution of the routinely-executed program by said processor and (ii) a resolution of the event, and to cause said processor to stop the execution when the occurrence is detected, and to cause said processor to resume the stopped execution when the resolution is detected, and
said selecting-and-requesting unit is configured to obtain information on the stopping and the resumption from said stopping-and-resumption control unit, and to select said processor including said stopping-and-resumption control unit when, according to the obtained information, said processor is in an operational state following the stop of the execution by said processor and preceding the resumption of the execution.

8. The multiprocessor system according to claim 6,
wherein each of said processors includes
a stopping-and-resumption control unit configured to detect (i) an occurrence of an event interrupting the execution of the routinely-executed program by said processor and (ii) a resolution of the event, and to cause said processor to stop the execution of the program when the occurrence is detected, and to cause said processor to resume the stopped execution when the resolution is detected, and
said selecting-and-requesting unit is configured to obtain information on the stopping and the resumption from said stopping-and-resumption control unit, and to determine whether or not to select said processor from which the information has been obtained, according to a history of the obtained information.
